(19) United States
(12) Patent Application Publication
(10) Pub. No.: US 2025/0309620 A1
(43) Pub. Date: Oct. 2, 2025

(54) MOUNTING APPARATUS FOR CIRCUIT BREAKER

(71) Applicant: Anker Innovations Technology Co., Ltd., Changsha (CN)

(72) Inventors: Yi Ouyang, Shenzhen (CN); Diyi Li, Shenzhen (CN)

(21) Appl. No.: 19/081,105

(22) Filed: Mar. 17, 2025

(30) Foreign Application Priority Data
Mar. 26, 2024 (CN) 202420604808.X

(51) Int. Cl. H02B 1/20

(52) U.S. Cl. CPC H02B 1/20

(57) ABSTRACT

The application describes a mounting apparatus for a circuit breaker. The mounting apparatus comprises a base and an electrical connector. The base comprises a base body and a limiting plate protruding from the base body. The limiting plate and the base body enclose a receiving groove. The receiving groove is configured to accommodate a terminal of the circuit breaker, and the connection plate is configured to be electrically connected to the terminal of the circuit breaker. The connection plane is located in the receiving groove and is configured to be connected to an external power output terminal.

### CROSS-REFERENCE TO RELATED APPLICATION

The present application claims priority to CN 202420604808.X, filed on Mar. 26, 2024, which is incorporated by reference by its entirety.

### TECHNICAL FIELD

The present application relates to the field of circuit breaker, in particular to a mounting apparatus for a circuit breaker.

### BACKGROUND

With the development of technology, people need to use various electrical devices in life and production. When an electrical device is used, a circuit breaker can be connected between a power source and the electrical device. When the electrical device is overloaded or short-circuited, the circuit breaker can cut off power supply to the electrical device, so as to ensure electrical safety.

When the circuit breaker is used, a mounting apparatus corresponding to the circuit breaker is often used to mount the circuit breaker. At present, the mounting apparatus for the circuit breaker, when connected to the power source, is only suitable for direct connection with a wire, but not suitable for connection with other types of power output terminals, and therefore, is limited in application scenarios.

### SUMMARY

The main technical problem to be solved by the present application is to provide a mounting apparatus for a circuit breaker. The mounting apparatus can be connected to a power output terminal of a sheet structure.

To solve the above technical problem, the technical solution adopted by the present application is to provide a mounting apparatus for a circuit breaker and a mounting system. The mounting apparatus comprises a base and an electrical connector. The base comprises a base body and a limiting plate protruding from the base body. The limiting plate and the base body enclose a receiving groove. The receiving groove is configured to accommodate a terminal of the circuit breaker, and the connection plate is configured to be electrically connected to the terminal of the circuit breaker. The connection plane is located in the receiving groove and is configured to be connected to an external power output terminal.

Beneficial effects of the present application are as follows: Different from the prior art, in the aforementioned mounting apparatus for the circuit breaker, the limiting plate can limit the relative movement between the circuit breaker and the base body or the electrical connector, thereby improving the stability of the circuit breaker during and after mounting, and improving the stability of electrical connection between the circuit breaker and the connection position. By configuring the connection plane, which can provide sufficient mounting space for the power output terminal of a sheet structure, the connection between the mounting apparatus and the power output terminal of the sheet structure is facilitated. The connection plane can further be used for abutting against the power output terminal of the sheet structure, thereby increasing the contact area between the electrical connector and the power output terminal of the sheet structure, and improving the reliability of electrical connection between the circuit breaker and the power output terminal.

### BRIEF DESCRIPTION OF THE DRAWINGS

FIG. 1 is a schematic diagram of a three-dimensional structure of a mounting assembly in an example of the present application;

FIG. 2 is a schematic structural diagram showing that a circuit breaker is connected to a power output terminal through the mounting assembly in the present application;

FIG. 3 is a schematic structural diagram showing that the circuit breaker is connected to another power output terminal through the mounting assembly in the present application;

FIG. 4 is a schematic structural diagram of a base of the mounting assembly in an example of the present application;

FIG. 5 is a schematic structural diagram of an electrical connector of the mounting assembly in an example of the present application;

FIG. 6 is a schematic structural diagram of one circuit breaker to which the mounting assembly is applied in an example of the present application;

FIG. 7 is a schematic diagram of an overlooked structure of the mounting assembly in an example of the present application; and

FIG. 8 is a schematic diagram of a process of mounting the circuit breaker in the mounting assembly in an example of the present application.

### DETAILED DESCRIPTION

The following clearly and completely describes the technical solutions in the present application in conjunction with the accompanying drawings therein. Apparently, the described examples are only some of the examples of the present application, not all of them. Based on the examples of the present application, all other examples obtained by those of ordinary skill in the art without any creative efforts shall fall within the scope of protection of the present application.

When an electrical device is used, a circuit breaker can be connected between a power source and the electrical device. When the electrical device is overloaded or short-circuited, the circuit breaker can cut off power supply to the electrical device, so as to ensure electrical safety. When the circuit breaker is used, a mounting assembly (e.g., a mounting apparatus, a mounting device) corresponding to the circuit breaker is often used to mount the circuit breaker. At present, the mounting assembly for the circuit breaker, when connected to the power source, is only suitable for direct connection with a wire, but not suitable for connection with other types of power output terminals, and therefore, is limited in application scenarios. To solve the technical problem, the present application provides the following solutions.

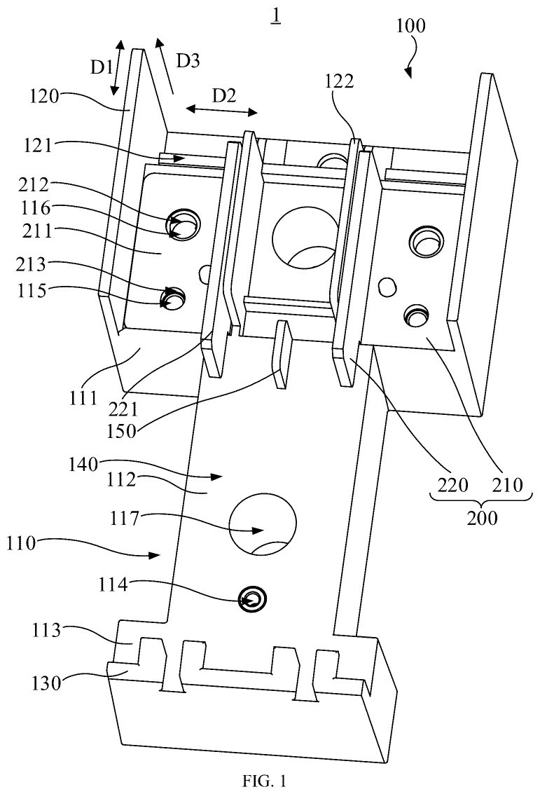

As shown in FIG. 1 to FIG. 3, a mounting assembly 1 for a circuit breaker includes a base 100 and an electrical connector 200. The base 100 includes a base body 110 and a first limit portion 120 (e.g., a plate), the first limit portion 120 protrudes from the base body 110, and the first limit portion 120 and the base body 110 enclose a receiving groove 121. A connection position 221 (e.g., a connection plate, a conductive plate) and a connection plane 211 are spaced apart on the electrical connector 200. The receiving groove 121 is used for accommodating a first terminal 401 of the circuit breaker 400, and the connection position 221 is used for being electrically connected to the first terminal 401 of the circuit breaker 400. The connection plane 211 is located in the receiving groove 121 and used for being connected to an external power output terminal 300. Further, at least a portion of the electrical connector 200 is arranged in the receiving groove 121 and connected to the base body 110.

The circuit breaker 400 can be mounted in an application scenario by the mounting assembly 1. For example, the circuit breaker 400 can be mounted in a power supply box by the mounting assembly 1. Specifically, the application scenario is provided with the power output terminal 300. During the operation of the circuit breaker 400, the mounting assembly 1 can be mounted and electrically connected to the power output terminal 300. The circuit breaker 400 can be mounted on the mounting assembly 1, the first terminal 401 of the circuit breaker 400 can be electrically connected to the mounting assembly 1, and a second terminal 402, spaced apart from the first terminal 401, of the circuit breaker 400, can be electrically connected to an electrical device, such that the circuit breaker 400 can be used for ensuring the electrical safety of the electrical device.

The mounting assembly 1 can be mounted through the base 100 and electrically connected to the circuit breaker 400 through the electrical connector 200. Specifically, the base 100 is made of an insulating material, the electrical connector 200 is made of a conductive material, and the connection position 221 and the connection plane 211 are electrically connected through a portion located between the connection position 221 and the connection plane 211. The base body 110 can be fixedly connected to a mounting position and support the circuit breaker 400, and the first limit portion 120 can limit the relative movement between the circuit breaker 400 and the base body 110, thereby improving the stability of the circuit breaker 400 during and after mounting. The first limit portion 120 can also limit the relative movement between the circuit breaker 400 and the electrical connector 200, thereby improving the stability of electrical connection between the circuit breaker 400 and the connection position 221.

The connection plane 211 facilitates the electrical connection between the mounting assembly 1 and the power output terminal 300 of a sheet structure. Specifically, the connection plane 211 can provide sufficient mounting space for the power output terminal 300 of the sheet structure, which facilitates the connection between the electrical connector 200 and the power output terminal 300 of the sheet structure. Further, the connection plane 211 can be used for abutting against the power output terminal 300 of the sheet structure, thereby increasing the contact area between the electrical connector 200 and the power output terminal 300 of the sheet structure, and improving the reliability of electrical connection between the circuit breaker 400 and the power output terminal 300. If the connection plane 211 is not configured, it is inconvenient to connect and fix the mounting assembly 1 with the power output terminal 300 of the sheet structure, which is not conducive to achieving reliable electrical connection between the circuit breaker 400 and the power output terminal 300.

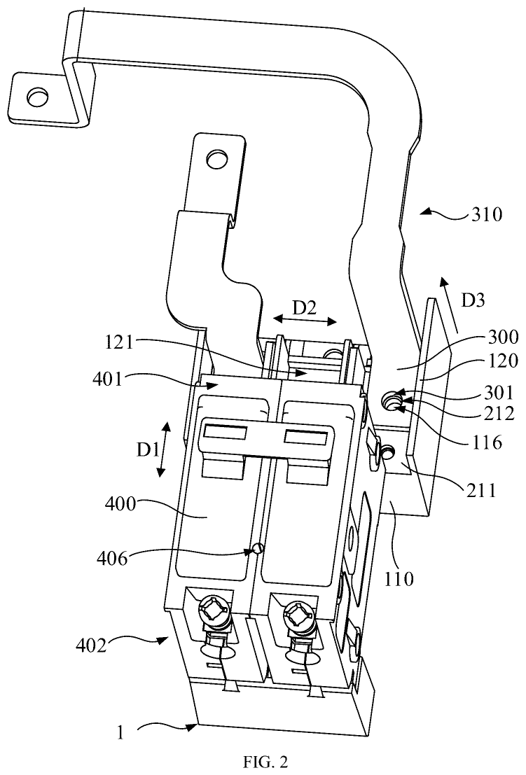

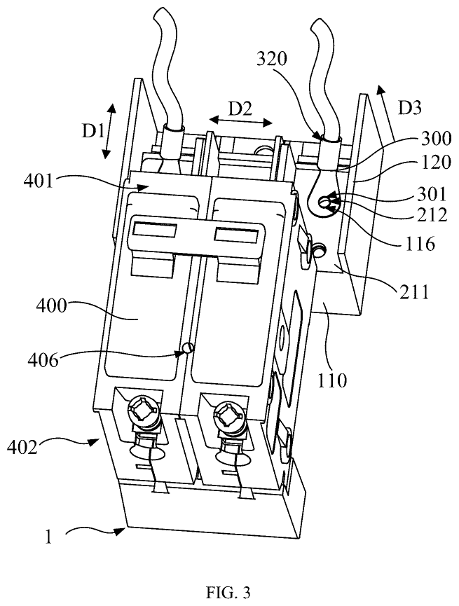

As shown in FIG. 2 and FIG. 3, the power output terminal 300 of the sheet structure may include a copper bar 310, a sheet portion of an OT terminal 320 (e.g., circular cold pressed terminal), etc. The OT terminal 320 can be connected to a wire in a power system, the OT terminal 320 has one opening, and the wire can be inserted into the opening. When the power source outputs current through the wire, the OT terminal 320 can be connected to the end of the wire away from the power source, such that the power output terminal 300 can have the sheet structure.

The inner wall of the receiving groove 121 includes a bottom wall and two opposite side walls. In some examples, the bottom wall of the receiving groove 121 may be located at the base 100, and the two opposite side walls of the receiving groove 121 may be located at the first limit portion 120.

The connection plane 211 is arranged in the receiving groove 121, the receiving groove 121 can provide space for mounting the power output terminal 300, and the side walls of the receiving groove 121 can limit the contact of the connection plane 211 and the power output terminal 300 with external conductors, thereby providing insulation protection and reducing the probability of short circuits. For example, when a plurality of mounting assemblies 1 are arranged adjacent to each other, the side walls of the receiving grooves 121 can limit the mutual contact between the connection planes 211 of different mounting assemblies 1 and between the power output terminals 300 corresponding to different mounting assemblies 1.

In some examples, in a protruding direction D3 of the first limit portion 120, the receiving groove 121 has a relatively small size, and the first terminal 401 of the circuit breaker 400 can be partially located in the receiving groove 121. As such, the size of the mounting assembly 1 can be reduced, and the mounting assembly 1 can be used in various application scenarios. In other examples, the first terminal 401 of the circuit breaker 400 can be completely located in the receiving groove 121.

The receiving groove 121 is configured to accommodate the first terminal 401 of the circuit breaker 400, such that the first limit portion 120 can limit the first terminal 401 of the circuit breaker 400. In some examples, the connection position 221 may be located inside or outside the receiving groove 121. In other examples, the connection position 221 may extend from the inside of the receiving groove 121 to the outside of the receiving groove 121.

Further, the base 100 has a length direction D1. When the circuit breaker 400 is mounted on the mounting assembly 1, a spacing direction between the first terminal 401 and the second terminal 402 of the circuit breaker 400 can be consistent with the length direction D1 of the base 100.

The receiving groove 121 can extend along the length direction D1, and the mounting assembly 1 can be used for mounting circuit breakers 400 of different sizes and specifications. When the size of the circuit breaker 400 is relatively large, the spacing between the first terminal 401 and the second terminal 402 of the circuit breaker 400 is relatively long, and the portion of the circuit breaker 400 located in the receiving groove 121 has a relatively large size in the length direction D1. When the size of the circuit breaker 400 is relatively small, the spacing between the first terminal 401 and the second terminal 402 of the circuit breaker 400 is relatively short, and the portion of the circuit breaker 400 located in the receiving groove 121 has a relatively small size in the length direction D1. The connection position 221 extends along the length direction D1 in the receiving groove 121, such that the connection positions 221 can form electrical connections with circuit breakers 400 of different sizes and specifications. As such, the compatibility of the mounting assembly 1 with the circuit breakers 400 of different sizes and specifications can be improved, and the mounting assembly 1 can be used in more application scenarios.

In an example, the mounting assembly 1 includes the base 100 and the electrical connector 200. The base 100 includes the base body 110 and the first limit portion 120. The first limit portion 120 protrudes from the base body 110, and the first limit portion 120 and the base body 110 enclose the receiving groove 121. The connection position 221 and the connection plane 211 are spaced apart on the electrical connector 200. The receiving groove 121 is configured to accommodate the first terminal 401 of the circuit breaker 400. The connection position 221 is configured to be electrically connected to the first terminal 401 of the circuit breaker 400, and the connection plane 211 is located in the receiving groove 121 and configured to be connected to the external power output terminal 300.

The first limit portion 120 can limit the relative movement between the circuit breaker 400 and the base body 110 or the electrical connector 200, thereby improving the stability of the circuit breaker 400 during and after mounting, and improving the stability of electrical connection between the circuit breaker 400 and the connection position 221. By configuring the connection plane 211, which can provide sufficient mounting space for the power output terminal 300 of the sheet structure, the connection between the mounting assembly 1 and the power output terminal 300 of the sheet structure is facilitated. The connection plane 211 can further be used for abutting against the power output terminal 300 of the sheet structure, thereby increasing the contact area between the electrical connector 200 and the power output terminal 300 of the sheet structure, and improving the reliability of electrical connection between the circuit breaker 400 and the power output terminal 300.

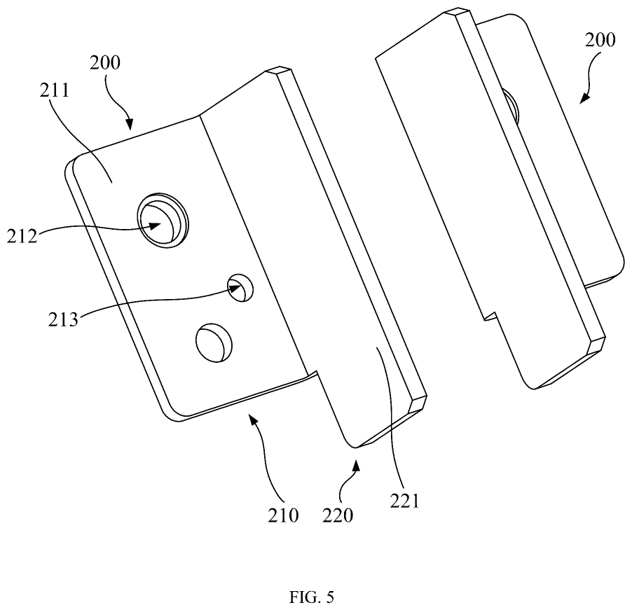

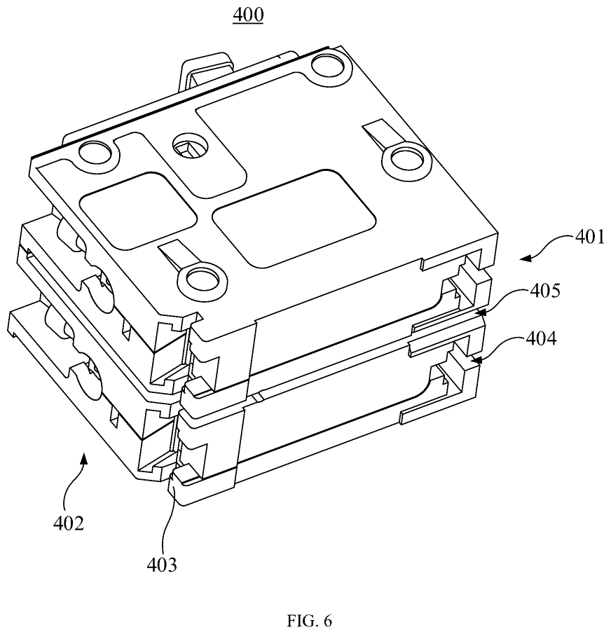

As shown in FIG. 1 and FIG. 4 to FIG. 6, the electrical connector 200 may include a first conductive sheet 210 and a second conductive sheet 220 connected to each other. The first conductive sheet 210 and the second conductive sheet 220 may be integrally molded. The first conductive sheet 210 can be arranged in the receiving groove 121 and can be fixedly arranged on the base body 110, and the connection plane 211 is arranged on the side of the first conductive sheet 210 away from the base body 110. At least a portion of the second conductive sheet 220 is arranged in the receiving groove 121, and the second conductive sheet 220 extends along the protruding direction D3 of the first limit portion 120. The connection position 221 is arranged on the second conductive sheet 220. The circuit breaker 400 is provided with a groove 404, and the connection position 221 is configured to be inserted into the groove 404 for electrical connection with the circuit breaker 400.

The first conductive sheet 210 and the second conductive sheet 220 may be integrally molded and connected, which can facilitate the molding and processing of the electrical connector 200. Further, the first conductive sheet 210 and the second conductive sheet 220 may be arranged at an angle, for example, the electrical connector 200 may be formed by bending a copper sheet.

The first conductive sheet 210 can facilitate the electrical connection between the power output terminal 300 and the electrical connector 200. The connection plane 211 is arranged on the side of the first conductive sheet 210 away from the base body 110, such that the connection plane 211 can be exposed, making it easy to connect the connection plane 211 with the power output terminal 300.

The portion, inserted into the groove 404, of the second conductive sheet 220 can serve as the connection position 221. The second conductive sheet 220 can facilitate the electrical connection between the circuit breaker 400 and the electrical connector 200. The second conductive sheet 220 extends along the protruding direction D3 of the first limit portion 120, such that the connection position 221 can extend along the protruding direction D3 of the first limit portion 120, which facilitates the insertion of the connection position 221 into the groove 404 for electrical connection with the circuit breaker 400 in the mounting process of the circuit breaker 400.

In some examples, as shown in FIG. 1, the first conductive sheet 210 is opposite to (e.g., corresponding to) and in contact with the base body 110, and the first conductive sheet 210 can be fixed to the base body 110 by, for example, screws. Specifically, the first conductive sheet 210 can be provided with a first fixing hole 213 in a penetrating manner, the base body 110 is provided with a first threaded hole 115, and a screw can pass through the first fixing hole 213 and extend into the first threaded hole 115 to fix the first conductive sheet 210 to the base body 110.

In other examples, by injection molding of the base body 110, the first conductive sheet 210 can be partially embedded in the base body 110, and the connection plane 211 can be exposed, so as to fix the first conductive sheet 210 to the base body 110.

As shown in FIG. 1 and FIG. 4 to FIG. 6, the first limit portion 120 may include a fixing plate 122. The fixing plate 122 is arranged in the receiving groove 121, and is arranged parallel to the two opposite side walls of the receiving groove 121. The second conductive sheet 220 abuts against the fixing plate 122, and the fixing plate 122 is configured to be inserted into the groove 404 to limit the relative movement between the circuit breaker 400 and the base 100.

The second conductive sheet 220 can be opposite to and in contact with the fixing plate 122, such that the fixing plate 122 can support the second conductive sheet 220, and the second conductive sheet 220 and the fixing plate 122 can be synchronously inserted into the groove 404 in the mounting process of the circuit breaker 400, which can improve assembly efficiency. Further, the second conductive sheet 220 and the fixing plate 122 can be tightly fitted with the groove 404, which is conducive to the close contact of the second conductive sheet 220 with the circuit breaker 400 in the groove 404 for stable electrical connection.

The two opposite side walls of the receiving groove 121 extend along the length direction D1. By arranging the fixing plate 122 parallel to the two opposite side walls of the receiving groove 121, both the fixing plate 122 and the second conductive sheet 220 can extend along the length direction D1, which is conducive to the electrical connection of the second conductive sheet 220 with the circuit breakers 400 of different sizes and specifications. The fixing plate 122 can further limit the circuit breakers 400 of different sizes and specifications, thereby improving the compatibility of the mounting assembly 1 with the circuit breakers 400 of different sizes and specifications.

As shown in FIG. 1, two opposite fixing plates 122 may be provided in the receiving groove 121, the mounting assembly 1 includes two electrical connectors 200 corresponding to the two fixing plates 122, one electrical connector 200 is located between the corresponding fixing plate 122 and one side wall of the receiving groove 121, and the other electrical connector 200 is located between the corresponding fixing plate 122 and the other side wall of the receiving groove 121.

As such, the two fixing plates 122 can support two second conductive sheets 220 respectively, and the two second conductive sheets 220 can be spaced apart to effectively prevent short circuits.

The two electrical connectors 200 include two first conductive sheets 210, and the two first conductive sheets 210 can be connected to a positive power output terminal 300 and a negative power output terminal 300 respectively. Correspondingly, the circuit breaker 400 can be provided with two grooves 404, the two fixing plates 122 are used for being inserted into the two grooves 404 respectively to limit the circuit breaker 400, and the two second conductive sheets 220 are used for being inserted into the two grooves 404 respectively, such that the circuit breaker 400 is electrically connected to the positive power output terminal 300 and the negative power output terminal 300 respectively.

As shown in FIG. 1 to FIG. 4, a connection hole 212 may be provided on the connection plane 211. The connection plane 211 is connected to the power output terminal 300 through the connection hole 212, or the electrical connector 200 is connected to both the power output terminal 300 and the base body 110 through the connection hole 212.

Specifically, the connection hole 212 penetrates the second conductive sheet 220, and the power output terminal 300 has a sheet structure and is provided with a second fixing hole 301. A threaded connector can be threaded through the second fixing hole 301 and the connection hole 212 to connect the second conductive sheet 220 and the power output terminal 300. Further, the base body 110 is provided with a second threaded hole 116 corresponding to the connection hole 212. A screw can be threaded through the second fixing hole 301, the connection hole 212, and the second threaded hole 116 to connect the base body 110, the second conductive sheet 220, and the power output terminal 300.

In other examples, the power output terminal 300 is a wire, and the wire can be inserted into the connection hole 212 to form an electrical connection with the second conductive sheet 220.

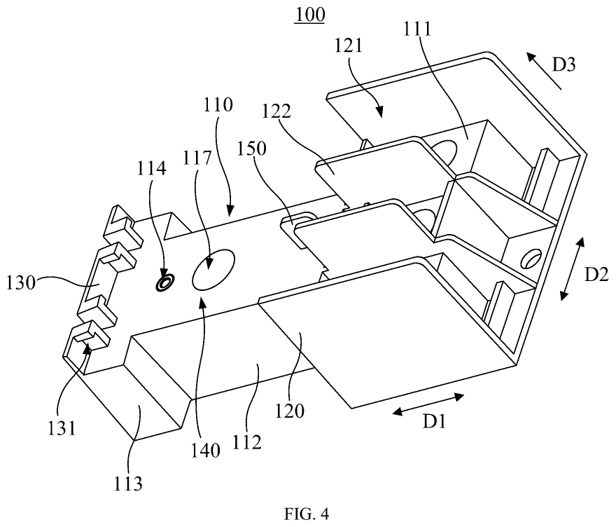

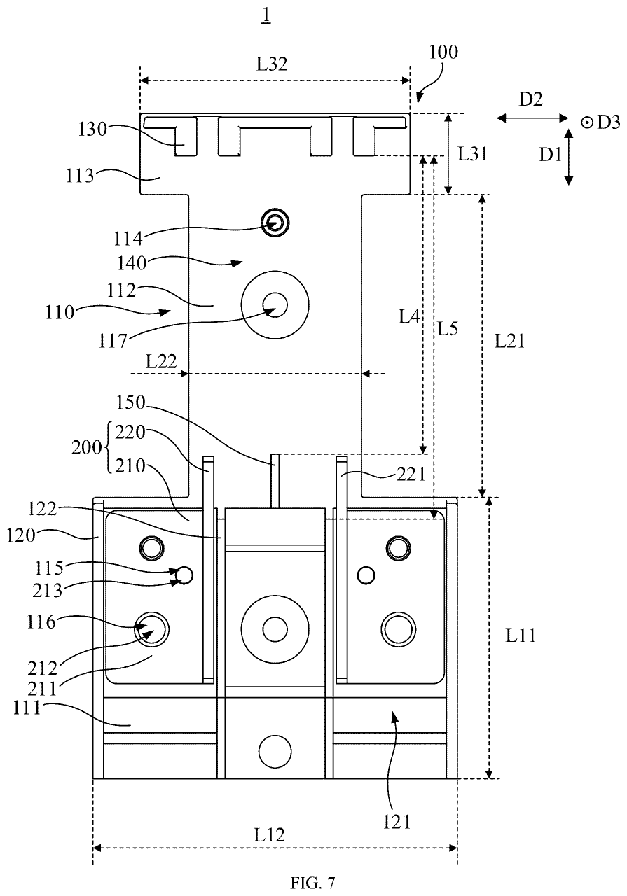

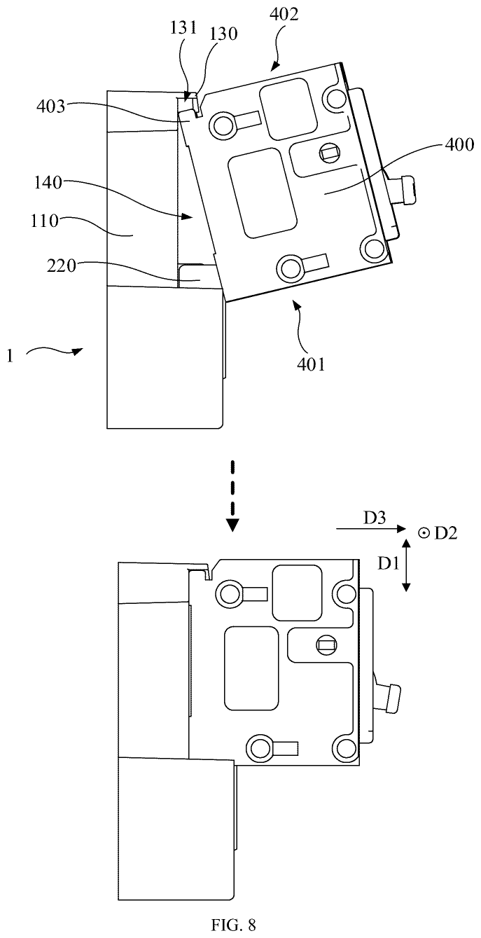

As shown in FIG. 4 and FIG. 6 to FIG. 8, the base 100 may further include a second limit portion 130 (e.g., a plate), the second limit portion 130 protrudes from the base body 110, the second limit portion 130 and the first limit portion 120 are spaced apart at two opposite ends of the base body 110, and both the second limit portion 130 and the first limit portion 120 are located on the same side of the base body 110. A limit mounting area 140 is formed between the second limit portion 130 and the first limit portion 120, and the limit mounting area 140 is in communication with the receiving groove 121. The second terminal 402, opposite to the first terminal 401, of the circuit breaker 400 is stopped at the second limit portion 130.

The limit mounting area 140 is used for accommodating the portion between the first terminal 401 and the second terminal 402 of the circuit breaker 400. In the mounting process of the circuit breaker 400, the second limit portion 130 and the first limit portion 120 can preliminarily fix the circuit breaker 400. The second limit portion 130 and the first limit portion 120 are conducive to accurate alignment of the circuit breaker 400 and the base 100, thereby facilitating the mounting of the circuit breaker 400.

Further, the second limit portion 130 and the first limit portion 120 can be spaced apart at the two opposite ends of the base body 110 along the length direction D1 of the base 100.

As shown in FIG. 4 and FIG. 6 to FIG. 8, the second limit portion 130 may be provided with a limit groove 131, the second terminal 402 of the circuit breaker 400 is provided with a limit protrusion 403, the limit protrusion 403 is used for being inserted into the limit groove 131, and the limit groove 131 is used for fixing the second terminal 402 of the circuit breaker 400 through the limit protrusion 403.

This setting facilitates the mounting of the circuit breaker 400 and is conducive to improving the stability of the circuit breaker 400 during and after mounting. In the mounting process of the circuit breaker 400, the second terminal 402 of the circuit breaker 400 can be first aligned with and get close to the second limit portion 130, such that the limit protrusion 403 is inserted into the limit groove 131. Then, the first terminal 401 of the circuit breaker 400 can get close to the first limit portion 120, such that the first terminal 401 of the circuit breaker 400 enters the receiving groove 121. Further, the first terminal 401 of the circuit breaker 400 gets close to the first limit portion 120, such that the second conductive sheet 220 and the fixing plate 122 can be synchronously inserted into the groove 404.

The second terminal 402 of the circuit breaker 400 may be provided with at least two limit protrusions 403. For example, the second terminal 402 of the circuit breaker 400 is provided with 4 limit protrusions 403. Correspondingly, the second limit portion 130 is provided with at least two limit grooves 131. For example, the second limit portion 130 is provided with 4 limit grooves 131. Further, the at least two limit grooves 131 can be spaced apart along a width direction D2 described below.

As shown in FIGS. 1, 4, and 7, the base body 110 may include a first sub base body 111, a second sub base body 112, and a third sub base body 113, where the first sub base body 111 and the third sub base body 113 are located at two opposite ends of the second sub base body 112 respectively. The first limit portion 120 is arranged on the first sub base body 111, and the second limit portion 130 is arranged on the third sub base body 113. The first sub base body 111, the second sub base body 112, and the third sub base body 113 are integrally molded or sequentially clamped.

By integrally molding the first sub base body 111, the second sub base body 112, and the third sub base body 113, the manufacturing process can be simplified and the assembly efficiency of the mounting assembly 1 can be improved. By sequentially clamping the first sub base body 111, the second sub base body 112, and the third sub base body 113, the mounting assembly 1 has a more flexible structure and better compatibility with application scenarios.

In an example, the base 100 has a length direction D1 perpendicular to the protruding direction D3, and the first sub base body 111 and the third sub base body 113 are located at the two opposite ends of the second sub base body 112 respectively along the length direction D1. In the length direction D1, the size L31 of the third sub base body 113 is less than the size L11 of the first sub base body 111, and the size L11 of the first sub base body 111 is less than the size L21 of the second sub base body 112. The base 100 further has a width direction D2 perpendicular to the length direction D1 and the protruding direction D3. In the width direction D2, the size L22 of the second sub base body 112 is less than the size L32 of the third sub base body 113, and the size L32 of the third sub base body 113 is less than the size L12 of the first sub base body 111.

The large size L21 of the second sub base body 112 in the length direction D1 can provide sufficient mounting space for the circuit breaker 400 and is conducive to the mounting of the circuit breaker 400. The small size L31 of the third sub base body 113 in the length direction D1 is conducive to reducing the overall size of the mounting assembly 1 and improving the compatibility of the mounting assembly 1 with application scenarios.

The large size L12 of the first sub base body 111 in the width direction D2 can provide sufficient mounting space for the electrical connector 200 and is conducive to the mounting of the electrical connector 200. The small size L22 of the second sub base body 112 in the width direction D2 facilitates holding the second sub base body 112 in the mounting process of the mounting assembly 1, and is conducive to improving the mounting efficiency.

As shown in FIG. 1 and FIG. 2, the second sub base body 112 may be provided with an assembly hole 114, the assembly hole 114 is in communication with the limit mounting area 140, and the circuit breaker 400 is fixed to the second sub base body 112 through the assembly hole 114.

The circuit breaker 400 can be provided with a third fixing hole 406 in a penetrating manner, where the third fixing hole 406 corresponds to the assembly hole 114. In the mounting process of the circuit breaker 400, after the first terminal 401 and the second terminal 402 of the circuit breaker 400 are clamped with the first limit portion 120 and the second limit portion 130 respectively, a screw can be threaded through the third fixing hole 406 and the assembly hole 114 to further fix the circuit breaker 400 and the second sub base body 112, thereby improving the mounting firmness of the circuit breaker 400.

As shown in FIG. 1, the base 100 may be provided with a fourth fixing hole 117, the fourth fixing hole 117 can allow a screw to pass through, and the base 100 is mounted in an application scenario through the fourth fixing hole 117. For example, the second sub base body 112 may be provided with the fourth fixing hole 117, and the portion of the first sub base body 111 between the two fixing plates 122 may also be provided with the fourth fixing hole 117.

As shown in FIGS. 2, 6, and 7, the circuit breaker 400 may be provided with an aligning groove 405. The base 100 further includes a limit plate 150, the limit plate 150 protrudes from the base body 110, the limit plate 150 is located on the same side of the base body 110 as the second limit portion 130 and the first limit portion 120, and the spacing distance L4 between the limit plate 150 and the second limit portion 130 is less than the spacing distance L5 between the first limit portion 120 and the second limit portion 130. The limit plate 150 is used for being inserted into the aligning groove 405 to limit the relative movement between the circuit breaker 400 and the base 100.

The limit plate 150 can enhance the limiting effect of the base 100 on the circuit breaker 400. For example, when the size of the circuit breaker 400 along the length direction D1 is small, the contact area between the circuit breaker 400 and the fixing plate 122 along the length direction D1 is small, and the limiting effect of the fixing plate 122 on the circuit breaker 400 is weak. Because the spacing distance L4 between the limit plate 150 and the second limit portion 130 is less than the spacing distance L5 between the first limit portion 120 and the second limit portion 130, the limit plate 150 can still effectively limit the circuit breaker 400, thereby ensuring that the base 100 has sufficient limiting effect on the circuit breaker 400.

As shown in FIG. 1 and FIG. 2, along the protruding direction D3, the second conductive sheet 220 may protrude from the first limit portion 120. For example, along the protruding direction D3, the second conductive sheet 220 protrudes from the fixing plate 122. As such, the second conductive sheet 220 is in sufficient and effective contact with an electrical connection contact of the circuit breaker 400, thereby improving the reliability of electrical connection between the electrical connector 200 and the circuit breaker 400.

As shown in FIG. 1 and FIG. 2, along a direction towards the second limit portion 130, the second conductive sheet 220 may protrude from the first limit portion 120. For example, along the direction towards the second limit portion 130, the second conductive sheet 220 protrudes from the fixing plate 122. As such, when the size of the circuit breaker 400 along the length direction D1 is small, the second conductive sheet 220 can be in sufficient and effective contact with the electrical connection contact of the circuit breaker 400, thereby improving the compatibility of the mounting assembly 1 with the circuit breakers 400 of different sizes and specifications.

The first limit portion 120 can limit the relative movement between the circuit breaker 400 and the base body 110 or the electrical connector 200, thereby improving the stability of the circuit breaker 400 during and after mounting, and improving the stability of electrical connection between the circuit breaker 400 and the second conductive sheet 220. By configuring the connection plane 211, which can provide sufficient mounting space for the power output terminal 300 of a sheet structure, the connection between the mounting assembly 1 and the power output terminal 300 of the sheet structure is facilitated. The connection plane 211 can further be used for abutting against the power output terminal 300 of the sheet structure, thereby increasing the contact area between the electrical connector 200 and the power output terminal 300 of the sheet structure, and improving the reliability of electrical connection between the circuit breaker 400 and the power output terminal 300.

Described above are only some of the examples of the present application, and the patent scope of the patent application is not limited thereto. Any equivalent structure or equivalent process transformation made using the description and accompanying drawings of the present application, directly or indirectly applied in other related technical fields, is also included in the scope of patent protection of the present application.

What is claimed is:

1. A mounting apparatus for a circuit breaker, comprising:
a base comprising a base body and a limiting plate, wherein the limiting plate protrudes from the base body, and the limiting plate and the base body enclose a receiving groove; and
an electrical connector comprising a connection plate and a connection plane, wherein:
the connection plate and the connection plane are spaced apart,
the connection plane is located in the receiving groove and is configured to be connected to an external power output terminal,
the receiving groove is configured to accommodate a terminal of the circuit breaker, and
the connection plate is configured to be electrically connected to the terminal of the circuit breaker.

2. The mounting apparatus according to claim 1, wherein:
the electrical connector comprises a first conductive sheet and a second conductive sheet connected to each other,
the first conductive sheet is arranged on the base body in the receiving groove, and
at least a portion of the second conductive sheet is arranged in the receiving groove.

3. The mounting apparatus according to claim 2, wherein:
the connection plane is arranged on a side of the first conductive sheet away from the base body,
the second conductive sheet extends along a protruding direction of the limiting plate, and
the connection plate is arranged on the second conductive sheet and is configured to be inserted into a groove of the circuit breaker.

4. The mounting apparatus according to claim 2, wherein:
the limiting plate is located in the receiving groove and parallel to two opposite side walls of the receiving groove,
the second conductive sheet abuts against the limiting plate, and
the limiting plate is configured to be inserted into a groove of the circuit breaker to limit relative movement between the circuit breaker and the base.

5. The mounting apparatus according to claim 1, further comprising:
a second electrical connector, wherein:
the base further comprises a second limiting plate,
the electrical connector is located between the limiting plate and one side wall of the receiving groove, and
the second electrical connector is located between the second limiting plate and another side wall of the receiving groove.

6. The mounting apparatus according to claim 1, wherein:
a connection hole is provided on the connection plane, and
the connection plane is connected to the power output terminal through the connection hole, or the electrical connector is connected to both the power output terminal and the base body through the connection hole.

7. The mounting apparatus according to claim 1, wherein:
the base further comprises a third limiting plate protruding from the base body,
the third limiting plate and the limiting plate are spaced apart at two ends of the base body and are located on a same side of the base body; and
a mounting area for the circuit breaker is formed between the third limiting plate and the limiting plate.

8. The mounting apparatus according to claim 7, wherein:
the third limiting plate comprises a limit groove, and
a second terminal of the circuit breaker comprises a protrusion configured to be inserted into the limit groove.

9. The mounting apparatus according to claim 7, wherein:
the base body comprises a first sub base body, a second sub base body, and a third sub base body, the first sub base body, the second sub base body, and the third sub base body being integrally molded or sequentially clamped,
the first sub base body and the third sub base body are located at two opposite ends of the second sub base body respectively, and
the limiting plate is arranged on the first sub base body, and the third limiting plate is arranged on the third sub base body.

10. The mounting apparatus according to claim 9, wherein:
the base has a length direction perpendicular to a protruding direction associated with the limiting plate,
the first sub base body and the third sub base body are located at the two opposite ends of the second sub base body respectively along the length direction,
in the length direction, a size of the third sub base body is less than that of the first sub base body, and the size of the first sub base body is less than that of the second sub base body, and
in a width direction perpendicular to the length direction and the protruding direction, the size of the second sub base body is less than that of the third sub base body, and the size of the third sub base body is less than that of the first sub base body.

11. The mounting apparatus according to claim 9, wherein:
the second sub base body comprises an assembly hole in communication with the mounting area, and
the circuit breaker is configured to be fixed to the second sub base body through the assembly hole.

12. The mounting apparatus according to claim 1, wherein:
the circuit breaker comprises an aligning groove,
the base further comprises a fourth limiting plate protruding from the base body, and
the fourth limiting plate is configured to be inserted into the aligning groove.

13. A mounting system comprising:
a circuit breaker; and
a mounting apparatus comprising:
a base comprising a base body and a limiting plate, wherein the limiting plate protrudes from the base body, and the limiting plate and the base body enclose a receiving groove; and
an electrical connector comprising a connection plate and a connection plane, wherein:
the connection plane is located in the receiving groove and is connected to an external power output terminal, and
the connection plate is electrically connected to the terminal of the circuit breaker.

14. The mounting system according to claim 13, wherein:
the electrical connector comprises a first conductive sheet and a second conductive sheet connected to each other,
the first conductive sheet is arranged on the base body in the receiving groove, and
at least a portion of the second conductive sheet is arranged in the receiving groove.

15. The mounting system according to claim 14, wherein:
the connection plane is arranged on a side of the first conductive sheet away from the base body,
the second conductive sheet extends along a protruding direction of the limiting plate, and
the connection plate is arranged on the second conductive sheet and is configured to be inserted into a groove of the circuit breaker.

16. The mounting system according to claim 13, wherein:
the mounting apparatus further comprises a second electrical connector,
the base further comprises a second limiting plate,
the electrical connector is located between the limiting plate and one side wall of the receiving groove, and
the second electrical connector is located between the second limiting plate and another side wall of the receiving groove.

17. The mounting system according to claim 13, wherein:
a connection hole is provided on the connection plane, and
the connection plane is connected to at least one of the power output terminal and the base body through the connection hole.

18. The mounting system according to claim 13, wherein:
the base further comprises a third limiting plate protruding from the base body,
the third limiting plate and the limiting plate are spaced apart at two ends of the base body and are located on a same side of the base body; and
a mounting area for the circuit breaker is formed between the third limiting plate and the limiting plate.

19. A mounting system comprising:
a circuit breaker;
an external power output terminal; and
a mounting apparatus comprising:
a base;
a limiting plate protruding from the base, and the limiting plate and the base enclose a receiving groove; and
an electrical connector comprising a connection plate and a connection plane, wherein:
the connection plane is located in the receiving groove and is connected to the external power output terminal,
the connection plate is electrically connected to the terminal of the circuit breaker, and
the limiting plate is configured to be inserted into a groove of the circuit breaker to limit relative movement between the circuit breaker and the base.

20. The mounting system according to claim 19, wherein the limiting plate is located in the receiving groove and parallel to two opposite side walls of the receiving groove.
